(19) United States
(12) Patent Application Publication
(10) Pub. No.: US 2004/0067468 A1
(43) Pub. Date: Apr. 8, 2004

(54) Coloring/painting kit and method

(76) Inventor: John Davy, Center Harbor, NH (US)

Correspondence Address: MESMER & DELEAULT, PLLC, 41 BROOK STREET, MANCHESTER, NH, 03104, US

(21) Appl. No.: 10/264,099

(22) Filed: Oct. 3, 2002

(51) Int. Cl. G09B 11/10

(52) U.S. Cl. 434/84

(57) ABSTRACT

A coloring/painting system has a picture material with a picture outline thereon. The picture outline has a plurality of picture areas where each picture area is outlined with a color indicative of the color to be applied thereto. A plurality of coloring media for applying to the plurality of picture areas is provided.

### BACKGROUND OF THE INVENTION

1. Field of the Invention

The present invention relates generally to the field of artistic painting. Particularly, the present invention relates to the field of reproducing a picture. More particularly, the present invention relates to kits for painting unpainted outlines and for coloring uncolored outlines on various types of media.

2. Description of the Prior Art

Over the years, there has been developed many different types of devices for aiding the unskilled artist in painting. These devices have included various sighting devices as well as the commonly known painting-by-number techniques in which the would-be painter merely follows a numbered code to fill in different areas of a printed pattern with pigments, the result being a picture. Kits for both children and adults have been devised using such paint-by-number techniques.

Most paint-by-numbers kits for use by the general public utilize a plurality of tubes of different color paint to be applied to a line representation of the image to be produced in color. The line-delineated areas of the picture to be painted are marked as to color by numbers corresponding to numbers on the receptacles, containers or tubes in which the color is supplied. For example, in a particular small area of a desired shade of blue, a tube of blue paint numbered with a numeral such as the numeral 9 would be intended for application to all of those areas of the line representation containing the numeral 9. There may be included some small color print indicating what the final appearance of the much larger picture ought to be.

U.S. Pat. No. 4,416,632 (1983, Berman) discloses a paint-by-numbers kit containing a panel board with a non-porous paper mounted thereon. The paper contains thereon a plurality of different unpainted picture areas and a plurality of different water-insoluble portions together constituting an unpainted picture to be painted by a user. Also contained in the kit is a plurality of different water-based paints for coloring the unpainted picture areas. The paints form a layer of transparent color on the non-porous paper of the panel board. Each unpainted picture area is associated with a water-soluble indicia number for indicating to the user which of the different paints to apply to each unpainted picture area. Each different paint is separately identified by a selector number which corresponds to an appropriate indicia number.

U.S. Pat. No. 4,109,399 (1978, Ivancevich) discloses an art kit consisting of a relieved pre-stroked panel on which figures of the subject matter are outlined by prominent (three-dimensional) strokes. The kit includes two color guide prints, whose every object and color have a corresponding stroke on the panel. This kit is also provided with a circular palette containing printed colors and usable quantities of the same colors. When in use, colors are first identified by comparing color samples on the palette with colors on the guide print, and then, applying the selected color to the appropriate spot of the panel. That particular spot is easily found, by comparing the object on the guide print with the corresponding object outlined with 3-D strokes on the panel.

U.S. Pat. No. 2,319,044 (1943, Di Lemme) discloses a paint set for the purpose of improving and developing the artistic ability of persons, especially older children, and holding their interest because of the satisfactory results that can be obtained even by the unskilled person. The invention employs a placard or chart of cardboard, wood, clay, or any other suitable material that will provide a relatively smooth surface. An outline of a pictorial subject, which is to be colored, is impressed upon the placard or chart. The outline forms a permanent color contrast with the coloring applied by the user of the set. The outline is made of a material that insures at all times the coloring being done within the outlined area will not run over the outline portion. The material of the outline gives the colored outlined subject or to contrasted colored outlined portions of such subject an appearance of expert workmanship although the coloring can be done by a novice.

U.S. Pat. No. 3,284,927 (1966, Milne) discloses a picture painting kit for use by an untrained person in the production of fully-colored paintings. The kit includes in combination at least two color reproductions of the same image of each of such subjects. Each color reproduction has a discrete rigid support of substantially the same physical size. One of the reproductions is fully color saturated in all areas. The other of the reproductions is substantially unsaturated as to color in each of the corresponding color areas thereof. The kit also includes separate painting media consisting of at least the primary colors, white and black, adapted to be mixed to form any of the image colors, and discrete instructions for mixing and applying color for each subject.

U.S. Pat. No. 3,447,250 (1969, Van Savage) discloses a painting guide kit having a plurality of guide sheets each having an arrangement of painting aid indicia successively corresponding to foreground and then background objects of a picture, and to be employed in painting a picture on the back side of a sheet of transparent material. The user overlays a sheet of transparent material successively on a plurality of guide sheets. The first of the guide sheets contains an arrangement of decorating or painting information denoting certain foreground objects in the picture, in mirror image, and the color they are to be painted. The transparent sheet on which the picture is to be made is placed over this sheet and the indicated color area painted on the back or non-viewing side of the transparent sheet so placed. Successive guide sheets have other decorating information imprinted thereon, corresponding first to intermediate details of the picture and later to background details. In this manner, as the painting progresses, larger and larger areas may be painted all on the back side of the transparent sheet without precise regard to the color boundaries and the previously painted areas are merely painted over. When completed, the transparent sheet is viewed from its front or viewing side and a complete picture is revealed. In addition, the first guide sheet may include lines corresponding to each of the elements of the picture and thereby defining the color boundaries of the picture.

Each of the prior art disclosures requires the use of an art guide mechanism that requires a multi-step identification process. In the paint-by-number case, the number in a particular area of a line representation image to be painted must be identified. The corresponding number must then be found on a paint container, and then the color associated with the number is identified as the color to be painted into the particular area. In kits where a full color guide print is used, a particular area to be painted in the color unsaturated image must be identified in the full color guide print. Once identified, the color within the corresponding area of the full color guide print must be compared to the colors of the paint containers provided in the kit. This multi-step color identification process is much more difficult for young children to complete than for adults.

Therefore, what is needed is a coloring or painting system that reduces the number of color identification steps required to paint a pre-outlined image. What is also needed is a coloring or painting kit that is easy to use by young children. What is further needed is a coloring or painting kit that can be used with clothing.

### SUMMARY OF THE INVENTION

It is an object of the present invention to provide a coloring/painting system that uses a simple, single step, color identification scheme. It is another object of the present invention to provide a coloring/painting kit that is easy to use by young children. It is a further object of the present invention to provide a coloring/painting kit that can be used to color/paint an outlined image on clothing.

The present invention achieves these and other objectives by providing a kit and method that includes a picture material having a plurality of picture areas wherein each of the picture areas is outlined with a color indicative of the color to be applied thereto and a plurality of coloring media for application to the plurality of picture areas. The plurality of picture areas generally define a pre-outlined, picture image on a material surface. The lining that defines the picture image and the plurality of picture areas is drawn with a color that is indicative of the color to be applied within the picture area defined by the particular line color.

The coloring media may be paints, watercolors, markers, crayons, colored pencils, and the like. The coloring media may be opaque or translucent, oil-based or water-based, and/or permanent or removable, depending on the application. The significant aspect of the present invention is the use of colored lining to define the color to be applied to a particular picture area. This is of particular importance in coloring and/or painting kits for use by younger children.

Younger children typically do not know how to read or write. They must attempt to match the “hieroglyphics” on the picture, i.e. numbers in paint-by-number kits, to those associated with the different paint colors. In addition, the concept of matching a numbered color to a number on a painting surface is difficult for young children to grasp. It is difficult for young children to complete a paint-by-number project without significant guidance from an older person. In those kits that provide a color reproduction of a completed work as a guide to determine the proper color to apply to a particular unpainted picture area, younger children suffer the same type of difficulty. They must match a painted picture area in the color reproduction of the completed work to an unpainted picture area in the picture outline. Oftentimes, it is difficult for young children to visualize similar shapes when one is painted and one is unpainted. Then, they must compare the color of the painted picture area with a matching colored paint in the paint set followed by painting the separate area.

The width of the lining used in the picture outline and the picture areas may vary from one another or they may all have the same width. The width of the lining may also vary depending on the age of the intended user. For example, younger children tend to have less manual dexterity and hand-eye coordination than older children and adults. In such a case, the width of the lining is preferably wider to account for errant coloring/painting strokes typically seen in colorings and paintings of younger children. As the user paints/colors an unpainted picture area, the user does not have to have as much control over the brush in an effort to avoid painting over the adjacent picture areas and colored outlines. The width of the lining and its color allows the picture area to be colored/painted with less concern about staying within the lines as the width can be made to accommodate the skill level and age of the user.

### BRIEF DESCRIPTION OF THE DRAWINGS

FIG. 1 is a perspective view of one embodiment of the present invention.

FIG. 2 is a top view of the outlined picture of the present invention.

FIG. 3 is an enlarged view of a portion of the outlined picture in FIG. 2 showing a partially painted picture area during painting thereof.

FIG. 4 is a view analogous to FIG. 3 showing the picture area after further painting thereof.

FIG. 5 is a perspective view of another embodiment of the present invention.

### DETAILED DESCRIPTION OF THE PREFERRED EMBODIMENT

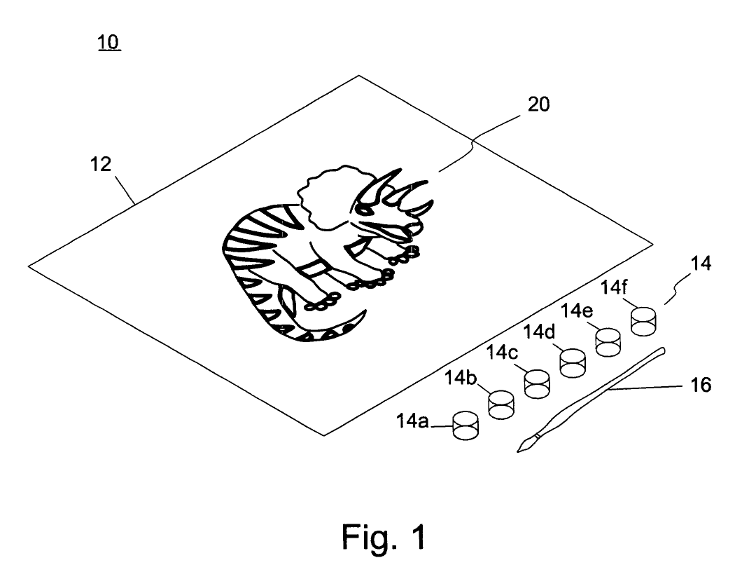

The various embodiments of the present invention is illustrated in FIGS. 1-5. Referring to FIG. 1, the reference numeral 10 denotes the coloring/painting kit of the present invention. Kit 10 includes a picture material 12 with an unpainted drawing 20 thereon, a plurality of coloring media or coloring components 14, and an artist's brush 16. Picture material 12 may be a porous or nonporous substrate. Kit 10 may also include a plurality of nonporous sheets which constitute a coloring book. Coloring media 14 typically comprises paint containers 14a, 14b, 14c, 14d, 14e, and 14f of different colors for applying to the unpainted picture 20. The paints are preferably water-based paints for ease of cleaning and for ease of removing a selected paint from artist's brush 16 when changing color during the application process. The paints may be in liquid form already including water as a carrier, or in a dry, solid form to be mixed with water. Brush 16 allows the user to apply paints from paint containers 14a, 14b, 14c, 14d, 14e, and 14f to unpainted drawing 20 to complete a painted picture.

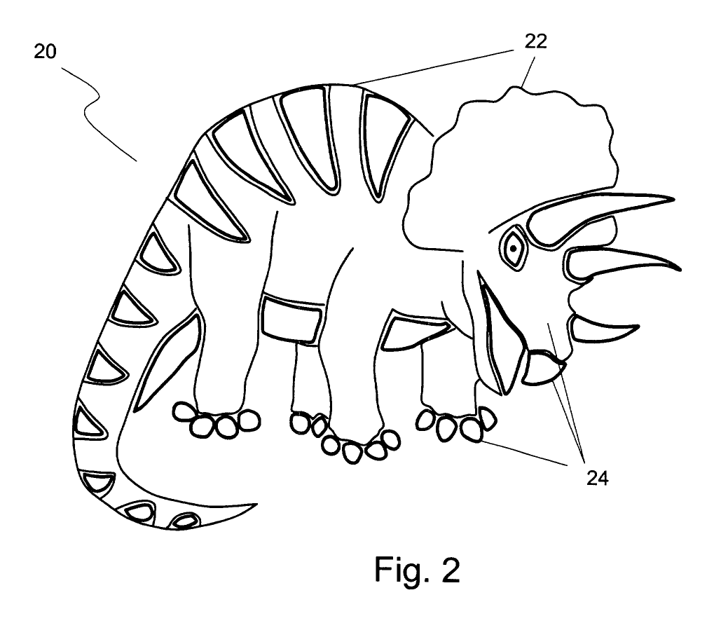

Turning now to FIG. 2, there is shown an enlarged view of the outlined drawing 20. Drawing 20 typically shows an outline 22 of a picture subject. Outline 22 includes a plurality of picture areas 24. In accordance with the method of the present invention, outline 22 and picture areas 24 are drawn with colored lines in a color that represents the color to be applied within the respective bounded areas. It should be understood that the distance between adjacent boundary lines is exaggerated for clarity. Adjacent boundary lines may abut one another or may partially overlap. Because these adjacent boundary lines are drawn in different colors, they are much more easily contrasted than illustrated herein.

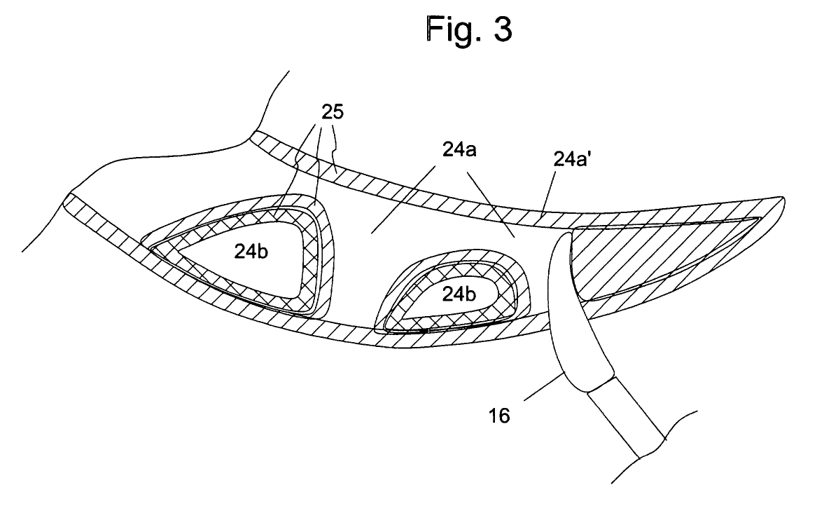

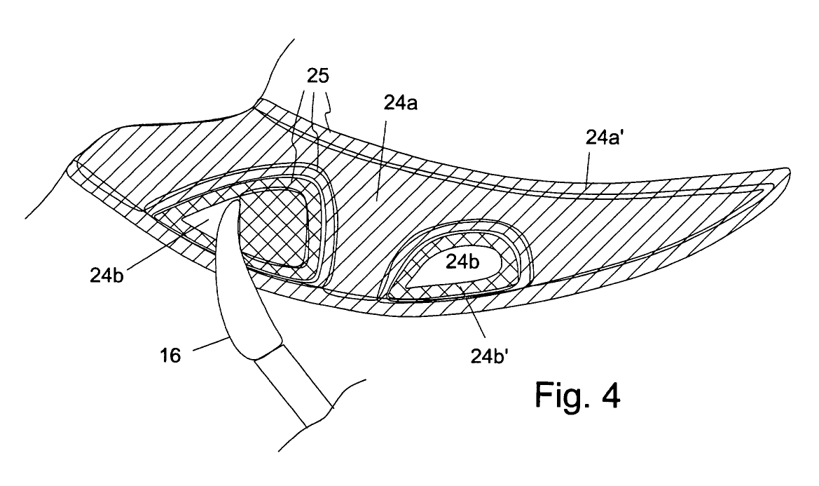

For example, outline 22 may be drawn in the color green while the plurality of picture areas 24 may be drawn in colors other than green such as red, blue, yellow, etc. As best seen in FIGS. 3 and 4 in accordance with the method of the present invention, the user dips brush 16 into one of the coloring paint containers 14a, 14b, 14c, 14d, 14e, and 14f. The user knows which paint container to dip brush 16 into by looking at the color of the outline associated with the picture area 24a the user wants to color in. The user chooses a paint color that corresponds to the color of the lined area in the unpainted picture area the user desires to color.

For example, if the user is about to paint the tail of the triceratops which is shown as picture area 24a, the user notes the color of the lining 24a′ used to border picture area 24a. The user looks at the paint containers 14a, 14b, 14c, 14d, 14e, and 14f and matches the color in a paint container that matches the color of the lining 24a′ used to border picture area 24a. The user dips brush 16 into the matching paint in the identified paint container and proceeds to color the unpainted picture area 24a. The principle is the same for all of the picture areas 24 in picture subject 20.

In this way, the method of the present invention serves its function, instructing the user in the most simplest terms which paint color should be applied to which picture area. This is of particular importance in painting kits for use by younger children. Younger children typically do not know how to read or write. They must attempt to match the “hieroglyphics,” i.e. the numbers, on the picture to those associated with the different paint colors. In addition, the concept of matching a numbered color to a number on a painting surface is difficult for young children to grasp. A consequence of this is that it is difficult for young children to complete a paint-by-number project without significant guidance from an older person. In those kits that provide a color reproduction of a completed work to follow, younger children suffer the same type of difficulty. They must match the shape of a painted picture area in the color reproduction of the completed work to the shape of a corresponding, unpainted picture area in the picture outline. Where pictures typically have a multitude of picture areas, this is especially difficult for younger children.

The width of the lining used in outline 22 and picture areas 24 may vary from one another or they may all have the same width. The width of the lining may also vary depending on the age of the intended user. For example, younger children tend to have less manual dexterity and hand-eye coordination than older children and adults. In such a case, the width of the lining is preferably wider to account for errant coloring/painting strokes typically seen in colorings and paintings of younger children. As the user paints/colors an unpainted picture area 24a, the user does not have to have as much control over the brush 16 in an effort to avoid painting over the adjacent picture areas 24b and color separating lines 25.

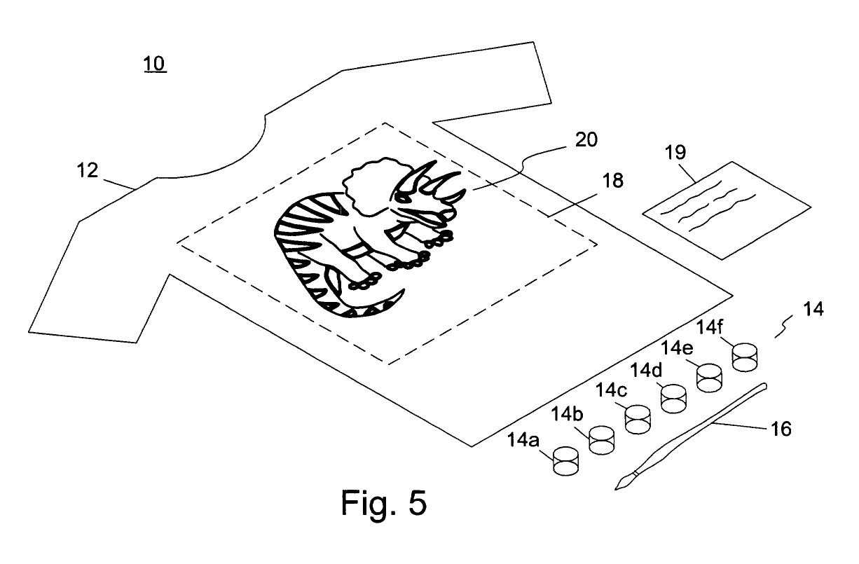

Referring now to FIG. 5, the drawing 20 of the coloring/painting kit 10 is preferably applied to a T-shirt 12. Also included is a removable backing sheet 18 which is located inside of T-shirt 12 beneath picture outline 20 to prevent any bleed-through of the paints onto the back of T-shirt 12. The paints in paint containers 14a, 14b, 14c, 14d, 14e, and 14f are water-based for faster drying and easier clean up. Water-based paints also allow the user to simply rinse brush 16 in water when changing colors during application.

The paints preferably form an opaque layer of color on T-shirt 12. In the preferred embodiment, four colored paints are included. Any number of different paints, though, may be included. The number of different paints included in kit 10 limits the number of different colors that can appear on the completed picture. In order to set the paints to T-shirt 12, it is preferable to heat the completed picture by ironing the completed picture on low to medium heat twenty-four hours or longer after completing the picture. Placing a protective cloth over the painted area before ironing prevents the unset paint from sticking to the hot iron surface.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A coloring/painting system comprising:
a picture material having a plurality of picture areas wherein each of said picture areas is outlined with a color indicative of the color to be applied thereto; and
a plurality of coloring media for application to said plurality of picture areas.

2. The kit of claim 1 wherein said picture material is porous or non-porous.

3. The kit of claim 2 wherein said article of clothing is a T-shirt.

4. The kit of claim 2 wherein said kit includes a plurality of non-porous sheets to constitute a coloring book.

5. The kit of claim 1 wherein said plurality of coloring media are one of paints, watercolors, markers, crayons, and colored pencils.

6. The kit of claim 2 further comprising a backing sheet for placement beneath said plurality of picture areas of said picture material when said picture material is porous.

7. A T-shirt kit comprising:
a T-shirt having an outlined picture thereon, said outlined picture having a plurality of picture areas wherein each of said picture areas is outlined with a color indicative of the color to be applied thereto; and
a plurality of coloring media for application to said plurality of picture areas.

8. The kit of claim 7 further comprising instructions for applying said plurality of coloring media to said T-shirt.

9. The kit of claim 7 wherein said plurality of coloring media are one of paints, watercolors, markers, crayons, and pencils.

10. The kit of claim 7 further comprising a removable backing for placement inside said T-shirt while applying said plurality of coloring media.

11. The kit of claim 7 further comprising an artist brush.

12. A method of producing color pictures, said method comprising:
providing a picture on a coloring-media receiving material wherein said picture has a plurality of picture areas to be colored, each of said plurality of picture areas being outlined in a color indicative of the color to be applied thereto; and
applying a selected coloring media from a plurality of coloring media directly over said picture area having an outline color corresponding to said selected coloring media.

13. The method of claim 12 further comprising heating said applied coloring media.

14. A method of using a coloring/painting kit comprising:
visually identifying a color of a portion of an outline of a pictorial subject pre-drawn on a coloring/painting substrate;
visually identifying a coloring material that corresponds to said outline color; and
applying said corresponding coloring material to said outline portion.

15. The method of claim 14 further comprising drying said applied coloring material for a predetermined time.

16. The method of claim 15 further comprising heating said applied coloring material after drying for said predetermined time.

17. A method of using a T-shirt coloring/painting kit comprising:
visually identifying a color of a portion of an outline of a pictorial subject pre-drawn on a portion of a T-shirt;
visually identifying a coloring component from a plurality of coloring media that corresponds to said outline color; and
applying said corresponding coloring component to said outline portion.

18. The method of claim 17 further comprising placing a backing material underneath said outline of said pictorial subject.

19. The method of claim 17 further comprising drying said applied coloring component for a predetermined time.

20. The method of claim 19 further comprising heating said applied coloring component after drying for said predetermined time.

21. The method of claim 20 wherein said heating step further includes placing a protective sheeting over said pictorial subject having said coloring component applied thereto and ironing said colored pictorial subject.
